(19) United States
(12) Patent Application Publication
(10) Pub. No.: US 2025/0011528 A1
(43) Pub. Date: Jan. 9, 2025

(54) MODIFIED NAPHTHOL RESIN AND PREPARATION METHOD THEREOF AND RESIN COMPOSITION INCLUDING THE SAME

(71) Applicant: NAN YA PLASTICS CORPORATION, TAIPEI (TW)

(72) Inventors: Te-Chao Liao, TAIPEI (TW); Hung-Yi Chang, TAIPEI (TW)

(73) Assignee: NAN YA PLASTICS CORPORATION, TAIPEI (TW)

(21) Appl. No.: 18/452,572

(22) Filed: Aug. 21, 2023

(30) Foreign Application Priority Data
Jun. 29, 2023 (TW) 112124188

(51) Int. Cl. C08G 61/10; C09D 165/02

(52) U.S. Cl. CPC C08G 61/10; C09D 165/02

(57) ABSTRACT

A modified naphthol resin having a structure as shown in [Formula 3] is provided.

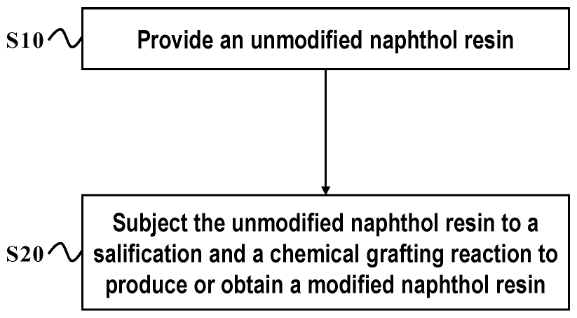

### CROSS-REFERENCE TO RELATED APPLICATION

This application claims the priority benefit of Taiwan application serial no. 112124188, filed on Jun. 29, 2023. The entirety of the above-mentioned patent application is hereby incorporated by reference herein and made a part of this specification.

### BACKGROUND OF THE INVENTION

### Field of the Invention

The invention relates to a resin and a preparation method thereof, in particular to a modified naphthol resin and a preparation method thereof.

### Description of Related Art

With the advancement of science and technology, electronic components are all being developed to be lightweight, thin, short, and small. Moreover, the advent of the 5th generation mobile networks (5G for short) has made the industry's demand for high-frequency transmission, high-speed signal transmission, and low latency continue to increase. Therefore, at present, related fields are committed to developing substrate materials having high glass transition temperature (Tg), low dielectric constant (Dk), low dissipation factor (Df), and good heat resistance to meet the needs of electronic substrates for dielectric properties (low dielectric constant, low dissipation factor) and heat resistance.

Common substrate materials include, for example, polyphenylene ether resin or cyanate resin, and these types of resins have good dielectric properties. However, they have higher reactivity and fast reaction rate, and therefore have the disadvantage of difficult determination of gel point, resulting in worse processability.

### SUMMARY OF THE INVENTION

The invention provides a modified naphthol resin, a preparation method thereof, and a resin composition containing the modified naphthol resin.

A preparation method of a modified naphthol resin of the invention includes the following steps: subjecting a naphthol resin to a salification and a chemical grafting reaction to form the modified naphthol resin having a terminal alkenyl group in a structure thereof. A reagent used in the chemical grafting reaction has the terminal alkenyl group.

The modified naphthol resin of the invention has a structure represented by [Formula 3] in the specification.

A resin composition of the invention includes the above modified naphthol resin.

An electronic element of the invention includes a film layer formed by the above resin composition.

Based on the above, the application of the modified naphthol resin is better in terms of glass transition temperature increase, coefficient of thermal expansion decrease, peel strength increase, water absorption decrease, and/or Dk/Df decrease.

### BRIEF DESCRIPTION OF THE DRAWINGS

FIGURE is a schematic flowchart of a preparation method of a modified naphthol resin according to an embodiment of the invention.

### DESCRIPTION OF THE EMBODIMENTS

In the following detailed description, for purposes of illustration and not limitation, exemplary embodiments disclosing specific details are set forth in order to provide a thorough understanding of the various principles of the invention. It will be apparent, however, to one of ordinary skill in the art, having the benefit of this disclosure, that the invention may be practiced in other embodiments that depart from the specific details disclosed herein. Moreover, descriptions of well-known devices, methods, and materials may be omitted so as not to obscure the description of the various principles of the invention.

Ranges may be expressed herein as from “about” one particular value to “about” another particular value, which may also be expressed directly as one particular value and/or to another particular value. When expressing the range, another embodiment includes from the one particular value and/or to another particular value. Similarly, when values are expressed as approximations, by use of the antecedent “about,” it will be understood that the particular value forms another embodiment. It will be further understood that an endpoint of each range is expressly related to the other endpoint or unrelated to the other endpoint.

In this specification, non-limiting terms (such as: may, can, for example, or other similar terms) refer to an optional or selective implementation, inclusion, addition, or presence.

Unless otherwise defined, all terms (including technical terms and scientific terms) used herein have the same meaning as commonly understood by one of ordinary skill in the art to which this invention belongs. It should be understood that, terms (such as those defined in commonly used dictionaries) should be interpreted to have meanings consistent with their meanings in the relevant technical background, and should not be interpreted in an idealized or overly formal sense, unless expressly so defined herein.

Please refer to FIGURE, the preparation method of the modified naphthol resin may include the following steps. Step S10: an unmodified naphthol resin is provided. Step S20: the unmodified naphthol resin is subjected to salification and chemical grafting reaction to form a modified naphthol resin.

### Unmodified Naphthol Resin

In an embodiment, the unmodified naphthol resin may be substituted with only hydrogen or an alkyl group with one to five carbons (can be counted as: C1 to C5) on the corresponding naphthol group

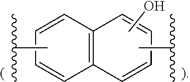

The naphthol group may include 1-naphthol group

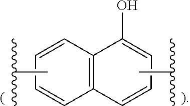

or 2-naphthol group

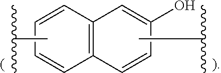

In an embodiment, the unmodified naphthol resin may not have any nitro group, nitroso group, or amine group on the corresponding naphthol group. In an embodiment, the unmodified naphthol resin does not have any nitro group, nitroso group, or amine group.

In an embodiment, the chemical formula of the unmodified naphthol resin may be shown in the following [Formula 1].

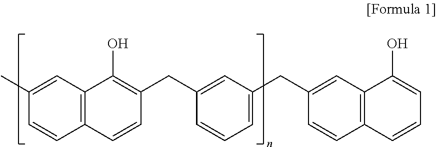

In [Formula 1], n may be a positive integer between 2 and 40.

In an embodiment, the chemical formula of the unmodified naphthol resin may be similar to [Formula 1]. For example, a hydrogen atom connected to a carbon atom may be substituted with an alkyl group with one to five carbons (can be counted as: C1 to C5). For another example, the hydroxyl group in the naphthol group may be located at other substituent positions.

In an embodiment, the number-average molecular weight (Mn) or weight-average molecular weight (Mw) of the polymer may be measured by gel permeation chromatography (GPC).

In an embodiment, the number-average molecular weight or weight-average molecular weight is used for estimation, and the average value of n may be in the range of 1 to 30.

In an embodiment, the unmodified naphthol resin may be commercially available (e.g.: ResiCare®4000, manufactured by Shanghai Hengfeng New Material Technology Co., Ltd.) or contained in a commercially available product.

### Salification of Unmodified Naphthol Resin

In an embodiment, the unmodified naphthol resin shown in [Formula 1] may ionize the terminal hydroxyl group in the naphthol group thereof by a suitable reaction, so as to be suitable for a subsequent reaction (such as: chemical grafting reaction).

In an embodiment, the terminal hydroxyl group in the naphthol group may be ionized by a suitable lye. Since the terminal hydroxyl group in the naphthol group is ionized by a suitable lye, the terminal hydroxyl group in the naphthol group may become the corresponding salt, so may also be called salification.

In an embodiment, the lye may include a solution containing alkali metal ions or alkaline earth metal ions; and is preferably a solution containing alkali metal ions. Cations with a valence greater than or equal to +3 may cause unwanted side reactions. For example, the lye may include sodium hydroxide, potassium hydroxide, sodium bicarbonate, potassium bicarbonate, sodium carbonate, potassium carbonate, or a mixed solution of the above dissolved in a suitable solvent (such as water, alcohol-water mixture).

In an embodiment, the pH value of the lye and/or the number of moles of hydroxyl ions therein may be suitably adjusted according to the total number of moles of the hydroxyl group in the naphthol resin.

In an embodiment, based on the composition of the original reactants, the ratio of the total number of moles of the hydroxyl group in the naphthol resin to the number of moles of the hydroxyl ions in the lye may be about 1:200 to 1:500; and is preferably about 1:250 to 1:400; and more preferably about 1:300 to 1:350. If the number of moles or concentration of the hydroxide ions is too low, the progress of the reaction may be reduced or the yield may be reduced. Excessive number of moles or concentration of the hydroxide ions may cause unwanted side reactions.

In an embodiment, the salified unmodified naphthol resin may be as shown in the following [Formula 2].

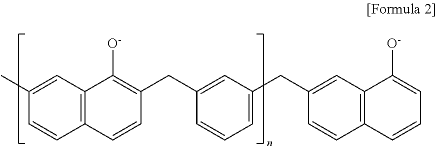

In [Formula 2], the definition of n is basically the same as the definition of n in the corresponding [Formula 2] thereof. The reason for “the definition of n is basically the same” mentioned above or in the following is that in a chemical reaction, there may be unintentional but unpredictable and/or unavoidable side reactions.

As shown in [Formula 2], the terminal hydroxyl group of the naphthol group in the unmodified naphthol resin may be ionized compared to the unsalified unmodified naphthol resin.

In an embodiment, compared with unsalified unmodified naphthol resin, salified unmodified naphthol resin may have higher water solubility and/or higher reactivity.

In an embodiment, during the process of ionizing the terminal hydroxyl group in the naphthol group, a suitable or suitable amount of catalyst may be added. In an embodiment, the catalyst is, for example, a quaternary ammonium compound (QAC). For example, the catalyst may include tetrabutylammonium bromide (TBAB), tetraethylammonium bromide (TEAB). The quaternary ammonium compound may provide good interfacial activity to the reactants and/or increase the rate of phase transfer.

### Chemical Grafting Reaction

For the unmodified naphthol resin after salification, the ionized terminal hydroxyl group thereof may be regarded as a nucleophile. Therefore, for the salified unmodified naphthol resin, the ionized terminal hydroxyl group may be grafted and substituted by means of nucleophilic substitution for corresponding modification.

The modified naphthol resin substituted by the graft may be represented by the following [Formula 3].

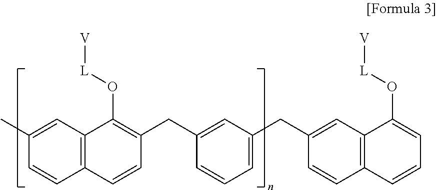

In [Formula 3], the definition of n is basically the same as the definition of n in the corresponding [Formula 1] and/or [Formula 2] thereof.

In [Formula 3], V may be a functional group having a terminal alkenyl group. In an embodiment, V may be a functional group having 2 to 3 carbon atoms and having a terminal alkenyl group. In an embodiment, V may be a vinyl group

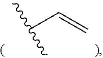 [SMILES: *C=C]

an allyl group

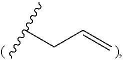 [SMILES: *CC=C]

or an isopropenyl group

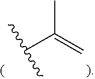 [SMILES: *C(=C)C]

In an embodiment, V may be a vinyl group or an isopropenyl group. That is, the modified naphthol resin has a terminal alkenyl group.

In [Formula 3], L is a linking group having a double bond. In an embodiment, L may be a linking group having 1 to 11 carbon atoms and having at least a double bond. In an embodiment, L may be a ketone group

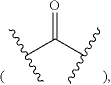 [SMILES: *C(*)=O]

an alkyl-substituted or unsubstituted phenylene group

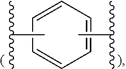

or an alkyl-substituted or unsubstituted methylbenzyl group

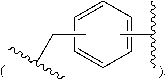

In an embodiment, L may be a ketone group or an alkyl-substituted or unsubstituted methylbenzyl group. In an embodiment, L may be a ketone group or a methylbenzyl group. The “alkyl substitution” mentioned above or later may be wherein at least one hydrogen is replaced by an alkyl group with one to five carbons (can be counted as: C1 to C5).

In an embodiment, the electrophile used in the chemical grafting reaction is a monomer molecule having a terminal alkenyl group. The monomer molecule may include halide, alkene halide, or alkene anhydride.

In an embodiment, the monomer molecule may include halomethylstyrene. Taking 4-halomethylstyrene as an example, it may be represented by the following [Formula 4].

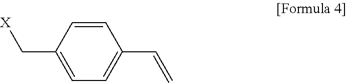

In [Formula 4], X may be a fluorine group, a chlorine group, a bromine group, or an iodine group. Preferably, X is chlorine (i.e., chloromethylstyrene).

In an embodiment, the monomer molecule may include acrylic anhydride, which may be shown in [Formula 5] below.

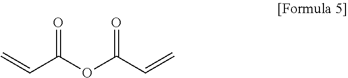

In an embodiment, the monomer molecule may include methacrylic anhydride, which may be shown in the following [Formula 6].

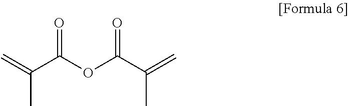

In an embodiment, the monomer molecule may include methacryloyl chloride, which may be shown in the following [Formula 7].

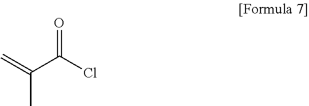

In an embodiment, taking the monomer molecule of 4-halomethylstyrene as an example, the modified naphthol resin may be as shown in the following [Formula 8].

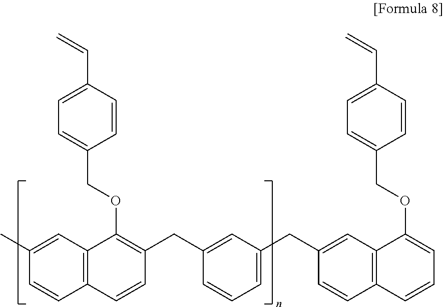

In [Formula 8], the definition of n is basically the same as the definition of n in the corresponding [Formula 1] and/or [Formula 2] thereof.

In an embodiment, taking the monomer molecule of methacrylic anhydride or methacryl chloride as an example, the modified naphthol resin may be as shown in the following [Formula 9].

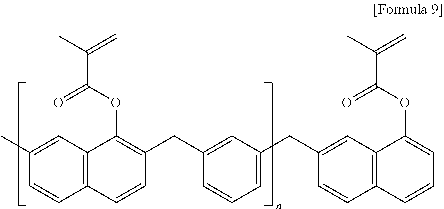

In [Formula 9], the definition of n is the same as the definition of n in the corresponding [Formula 1] and/or [Formula 2] thereof.

### Application of Modified Naphthol Resin

Since the modified naphthol resin shown in [Formula 8] or [Formula 9] may have lower dielectric properties, higher glass transition temperature (Tg), lower coefficient of thermal expansion (CTE), and/or better heat resistance, the modified naphthol resin shown in [Formula 8] or [Formula 9] may be suitable for the application of electronic products.

Since the modified naphthol resin shown in [Formula 8] or [Formula 9] may be readily dissolved in a common organic solvent (such as: toluene or methyl ethyl ketone (MEK), the modified naphthol resin shown in [Formula 8] or [Formula 9] is more convenient to use.

In an embodiment, the modified naphthol resin shown in [Formula 8] or [Formula 9] may have better dielectric properties, heat resistance, flame retardancy, low hygroscopicity, and/or adhesion in the application of electronic products.

In an embodiment, the resin composition may include the modified naphthol resin in an above embodiment. For example, the basic formula (i.e., the total resin composition) in the resin composition includes at least the modified naphthol resin of an above embodiment.

In an embodiment, the modified naphthol resin may be 30 parts by weight (wt %) to 60 parts by weight based on 100 parts by weight of the basic formula (i.e., the total resin composition) in the resin composition; and is preferably 40 parts by weight to 50 parts by weight.

In an embodiment, the basic formula in the resin composition may further include a bismaleimide resin. In an embodiment, the bismaleimide resin may be 10 parts by weight (wt %) to 30 parts by weight based on 100 parts by weight of the basic formula in the resin composition; and is preferably 15 parts by weight to 25 parts by weight.

In an embodiment, the basic formula in the resin composition may further include other polymers. In an embodiment, the other polymers may be 20 parts by weight (wt %) to 50 parts by weight based on 100 parts by weight of the basic formula in the resin composition; and is preferably 30 parts by weight to 40 parts by weight.

In an embodiment, the other polymers are not naphthol resin (whether modified or not). In an embodiment, the other polymers do not have a naphthol group. In an embodiment, the other polymers do not have a functional group derived from a naphthol group (e.g., a salified, esterified, or etherified naphthol group). In an embodiment, the other polymers may include a styrene/butadiene copolymer (such as: poly (styrene-butadiene-styrene) (SBS)) or a derivative thereof. The styrene/butadiene copolymer or the derivative thereof may be commercially available (example: manufactured by TSRC, LCY Chemical Corp, Nippon Soda) and is often referred to as synthetic rubber.

In an embodiment, the resin composition may further include an additive formula. The additive formula is substantially free of resins, polymers, or the like. The additive formula may include, for example, flame retardant, inorganic filler, or a combination of the above.

In an embodiment, the addition of the flame retardant may improve the flame resistance or flame retardancy of the resin composition. As used herein, “flame resistant” or “flame retardant” means that the referenced object (e.g., film, layer, or structure) may pass the flame retardancy criteria of a standard test method. For example, taking the UL94 plastic flammability standard (Test for Flammability of Plastic Materials for Parts in Devices and appliances) issued by Underwriters Laboratories Inc (UL) as an example, it is at least the HB level.

In an embodiment, the flame retardant includes a bromine-based flame retardant, a phosphorus-based flame retardant, or a combination thereof.

In an embodiment, the addition of the inorganic filler may increase the viscosity of the resin composition. For example, the inorganic filler may be: silica, titanium dioxide, aluminum hydroxide, aluminum oxide, magnesium hydroxide, magnesium oxide, calcium carbonate, boron oxide, calcium oxide, strontium titanate, barium titanate, calcium titanate, magnesium titanate, boron nitride, aluminum nitride, silicon carbide, cerium dioxide, or a combination of the above.

In an embodiment, the silica used as the inorganic filler may include fused silica or crystalline silica. In an embodiment, considering the dielectric properties when applied to a copper foil substrate, fused silica is more preferred.

In an embodiment, the titanium dioxide used as the inorganic filler may include titanium dioxide in a rutile, anatase, or brookite configuration. In an embodiment, considering the dielectric properties when applied to a copper foil substrate, titanium dioxide in rutile configuration is more preferred.

In an embodiment, based on 100 parts by weight of the basic formula in the resin composition, the flame retardant may be added in an additional 20 parts by weight to 40 parts by weight to be calculated as 20 PHR (parts per hundred parts of resin) to 40 PHR; preferably, about 25 PHR to 35 PHR.

In an embodiment, based on 100 parts by weight of the basic formula in the resin composition, the inorganic filler may be added in an additional amount of 50 parts by weight to 70 parts by weight to be calculated as 50 PHR to 70 PHR; preferably, about 55 PHR to 65 PHR.

In an embodiment, the resin composition may be used in the manufacture of an electronic element (such as: copper foil substrate or printed circuit board, but not limited).

### Manufacture of Copper Foil Substrate

The modified naphthol resin of an above embodiment may be dissolved and mixed with other components in a suitable solvent to be used as a resin varnish, and a copper foil substrate may be prepared by a conventional method. For example, the resin composition of an above embodiment may be dissolved in a suitable solvent to be used as a resin varnish, and may be used in the manufacture of a copper foil substrate.

A manufacturing method of a copper foil substrate may be as follows.

2116 fiberglass cloth was impregnated with the above resin varnish and then dried at about 170° C. (impregnation machine temperature) for several minutes, and by adjusting and controlling the drying time, the melt viscosity of the prepreg after drying was obtained to be between about 4000 poise and 12000 poise. Then, four pieces of prepreg were stacked between two pieces of copper foil with a thickness of about 35 μm, and a pressing step was performed (details are described later), so as to form a copper foil substrate of an embodiment.

The conditions/processes of the pressing step are as follows:

Step 1: the temperature was raised from about 80° C. to about 195° C. at a speed of about 0.5 hours (can be recorded as: 85 [symbol] 195° C., 0.5 hr).

Step 2: the pressure was increased from about 7 kg/cm² to about 25 kg/cm² at a rate of about 0.5 hours (can be recorded as: 7 [symbol] 25 kg/cm², 0.5 hr)

Step 3: pressing was performed at a temperature of about 195° C. and a pressure of about 25 kg/cm² for about 2.0 hours (recorded as: 195° C./25 kg/cm², 2.0 hr).

### Preparation Examples of Modified Naphthol Resin

Examples and comparative examples are shown below to specifically describe the invention, but the invention is not limited by the following examples at all.

### Example 1-1

About 100 grams of commercially available unmodified naphthol resin (trade name ResiCare® 4000, manufactured by Shanghai Hengfeng New Material Technology Co., Ltd., represented by Suiye Industry; wherein including the unmodified naphthol resin as shown in [Formula 1]) was taken, and the hydroxyl value thereof (or called: OH value) was about 141. The hydroxyl value may be calibrated by a commonly used standard (such as: including but not limited to: ISO 4629-2:2016, ASTM E222-10, GB/T 12008.3, CNS 6681). Next, about 100 g of the above unmodified naphthol resin and about 113 grams of 4-chloromethylstyrene were put into a reaction vessel of suitable capacity, and the mixture was diluted with a suitable amount of toluene until the solid content accounted for about 30 wt % of the weight of the reactants (that is, the above unmodified naphthol resin and chloromethyl styrene), wherein the amount of toluene used was about 498 grams. Moreover, about 1 gram of tetrabutylammonium bromide (can be used as a catalyst) was put into the reaction vessel.

The reactants (i.e., a toluene solution in which the above unmodified naphthol resin and chloromethylstyrene were dissolved, not limited to complete dissolution, and containing a tetrabutylammonium bromide catalyst) were stirred and heated to about 70° C. with a suitable stirring bar.

After the reactants were stirred and heated to about 70° C., about 50 wt % sodium hydroxide aqueous solution was continuously added dropwise to a total of about 68 g over a period of about 2 hours, with constant stirring and constant temperature (about 70° C.) during the process.

After the dropwise addition was completed, the reaction was continued for about 4 hours under constant temperature (about 70° C.) with constant stirring.

After the reaction, the reaction solution was poured into a methanol solution about 5 times the volume thereof to precipitate the product. The precipitated product may be collected by filtration. Moreover, after washing several times with methanol and water, a modified naphthol resin as shown in [Formula 8] may be obtained, and the corresponding number is A1, which may be abbreviated as: Al modified resin.

### Example 1-2

Prepared with the same or similar steps as <Example 1-1>. The difference is: the relative amount of chloromethyl styrene and naphthol resin was adjusted. Specifically, in <Example 1-1>, the number of moles of chloromethylstyrene was 1.05 times the total number of moles of the hydroxyl group in naphthol resin (can be recorded as: equivalent ratio 1.05); in <Example 1-2>, the number of moles of chloromethylstyrene was 1.07 times the total number of moles of the hydroxyl group in the naphthol resin (may be recorded as: equivalent ratio 1.07).

The method of <Example 1-2>may produce the modified naphthol resin shown in [Formula 8], the corresponding number is A2, which may be referred to as: A2 modified resin.

A1 modified resin and A2 modified resin may be similar in structure, the difference is that the chain length distribution of the product is slightly different due to the difference in corresponding equivalents during preparation. The chain length distribution may be determined by the polydispersity index described later.

### Example 1-3

About 100 grams of the same unmodified naphthol resin used in <Example 1-1> was obtained. Then, about 100 g of the unmodified naphthol resin was put into a reaction vessel of suitable capacity and diluted with a suitable amount of toluene until at least completely dissolved, wherein the amount of toluene used was about 498 grams. Moreover, about 1 gram of tetrabutylammonium bromide (can be used as a catalyst) was put into the reaction vessel. During the process of adding the unmodified naphthol resin, toluene, and/or tetrabutylammonium bromide, stirring was performed with a suitable stirring bar and heating was performed to about 70° C.

After heating to about 70° C., at a constant temperature (about 70° C.), about 68 g of about 50 wt % sodium hydroxide aqueous solution was directly added to react for about 1 hour, and stirring was continuously performed during the process to produce the salified naphthol resin as shown in [Formula 2].

Next, about 4.37 grams of methacrylic anhydride (such as: [Formula 6]) was continuously added dropwise for about 1 hour to a total of about 68 g, and stirring was continuously performed and a constant temperature (about 70° C.) was kept during the process.

After the dropwise addition was completed, the reaction was continued for about 10 hours under constant temperature (about 70° C.) with constant stirring.

After the reaction, the reaction solution was poured into a methanol solution about 5 times the volume thereof to precipitate the product. The precipitated product may be collected by filtration. Moreover, after washing several times with methanol and water, a modified naphthol resin as shown in [Formula 9] may be obtained, and the corresponding number is A3, which may be abbreviated as: A3 modified resin.

### Example 1-4

Prepared with the same or similar steps as <Example 1-3>. The difference is: the relative amount of methacrylic anhydride and naphthol resin was adjusted. Specifically, in <Example 1-3>, the number of moles of methacrylic anhydride was 1.05 times the total number of moles of the hydroxyl group in naphthol resin (can be recorded as: equivalent ratio 1.05); in <Example 1-4>, the number of moles of methacrylic anhydride was 1.07 times the total number of moles of the hydroxyl group in the naphthol resin (may be recorded as: equivalent ratio 1.07).

The method of <Example 1-4> may produce the modified naphthol resin shown in [Formula 9], the corresponding number is A4, which may be referred to as: A4 modified resin.

A3 modified resin and A4 modified resin may be similar in structure, the difference is that the chain length distribution of the product is slightly different due to the difference in corresponding equivalents during preparation. The chain length distribution may be determined by the polydispersity index described later.

The resulting modified naphthol resins were evaluated by each of the following evaluation methods, and the results thereof are shown in [Table 1].

TABLE 1

| Item | Example 1-1 | Example 1-2 | Example 1-3 | Example 1-4 |
|---|---|---|---|---|
| Number | A1 | A2 | A3 | A4 |
| Reactant | Chloromethylstyrene | | Methacrylic anhydride | |
| OH equivalent ratio | 1.05 | 1.07 | 1.05 | 1.07 |
| Hydroxyl conversion rate | 99.8 | 99.9 | 99.7 | 99.9 |
| (%) | | | | |
| Mn (g/mol) | 786 | 808 | 752 | 768 |
| Mw (g/mol) | 1072 | 1222 | 968 | 994 |
| PDI (i.e., about Mw/Mn) | 1.36 | 1.51 | 1.29 | 1.29 |
| Survival of monomer (%) | 0.21 | 0.25 | 0.15 | 0.22 |

### Evaluation Method

Hydroxyl group transformation efficiency: may be obtained by comparing the hydroxyl values of the reactants before the reaction with the hydroxyl value of the product after the reaction. For example, if the hydroxyl values of the reactants before the reaction was about 141, and the hydroxyl value of the product after the reaction was about 0.3, the hydroxyl conversion rate was about 99.8 (calculation formula: 1-0.3/141≈99.8%). The closer the hydroxyl conversion rate was to 100%, the more hydroxyl groups were converted.

Number-average molecular weight (Mn): the prepared modified naphthol resins were dissolved in tetrahydrofuran (THF) to prepare a solution to be tested with a concentration of 1 wt %. Next, the number-average molecular weight of the solution to be tested was measured by gel permeation chromatography (GPC).

Weight-average molecular weight (Mw): the prepared modified naphthol resins were dissolved in tetrahydrofuran (THF) to prepare a solution to be tested with a concentration of 1 wt %. Next, the weight-average molecular weight of the solution to be tested was measured by gel permeation chromatography (GPC).

Polydispersity index (PDI): the measured weight-average molecular weight was divided by the measured number-average molecular weight (i.e., Mw/Mn) to obtain the polydispersity index (PDI). The smaller the PDI, the more concentrated the molecular weight distribution was. Under the same or similar conditions of initial reactants, catalysts, and the corresponding amounts thereof, the smaller the PDI, the smaller the possibility of the corresponding side reactions, and the more concentrated the molecular weight distribution. Therefore, if the molecular weight distribution was more moderate (i.e., the PDI was smaller), the functional groups, the morphology, and/or the structure were more uniform, and a more uniform reaction/synthesis was achieved. Moreover, if the molecular weight distribution was more moderate (that is, the PDI was smaller), the proportion of side reaction products (such as: larger polymer molecules formed by repolymerization) may also be relatively less. Therefore, in terms of product application, it may be more stable for subsequent processing or application, so that the subsequent processed products may have better quality or better yield.

Monomer residues: by a suitable quantitative method (such as: titration analysis or spectral analysis, but not limited to), the amount of unreacted chloromethyl styrene (<Example 1-1> or <Example 1-2>) or unreacted methacrylic anhydride (<Example 1-3> or <Example 1-4>) was measured and estimated, in order to estimate the remaining proportion thereof.

### Examples and Comparative Examples of Application to Copper Foil Substrate

A resin varnish composition was formed from the formula composition ratios shown in [Table 2] and [Table 3], and a copper foil substrate was prepared by the above method.

In the formula compositions in <Comparative example>, <Example 2-1>, <Example 2-2>, <Example 2-3>, <Example 2-4>, <Example 2-5>, corresponding basic formulas and additive formulas were included. The corresponding weight percentage (wt %) of each component included in the basic formula may be shown in [Table 2] and [Table 3]. In addition, each component in the additive formula was additionally added based on the total weight of the basic formula. Taking <Comparative example> as an example, if the weight of the basic formula was 100 parts by weight, the additive formula included 30 parts by weight of flame retardant to be counted as 30 PHR (parts per hundred parts of resin); and 60 parts by weight of flame retardant may be counted as 60 PHR.

In <Comparative example>, the polyphenylene ether resin used was commercially available Saudi Basic Industries Corporation (SABIC) MX-90 resin.

The BMIs used in <Comparative example>, <Example 2-1>, <Example 2-2>, <Example 2-3>, <Example 2-4>, <Example 2-5> were the same, and may be the commercially available BMI-70 series bismaleimide (BMI) resin sold by Japan KI Chemical Industry Co., Ltd.

The synthetic rubbers used in <Comparative example>, <Example 2-1>, <Example 2-2>, <Example 2-3>, <Example 2-4>, <Example 2-5> were the same, and may be a commercially available Nippon Soda Co., Ltd. SBS rubber.

The flame retardants used in <Comparative example>, <Example 2-1>, <Example 2-2>, <Example 2-3>, <Example 2-4>, <Example 2-5> were the same, and may include the commercially available OP935 series flame retardant sold by Clariant AG.

The inorganic fillers used in <Comparative example>, <Example 2-1>, <Example 2-2>, <Example 2-3>, <Example 2-4>, <Example 2-5> were the same, and may include the commercially available 525ARI series silica filler sold by Sibelco.

TABLE 2

| | | Comparative | Example | Example |
|---|---|---|---|---|
| | | example | 2-1 | 2-2 |
| Basic | Polyphenylene ether resin | 45 | 0 | 0 |
| formula | (wt %) | | | |
| | A1 modified resin (wt %) | 0 | 45 | 0 |
| | A2 modified resin (wt %) | 0 | 0 | 45 |
| | BMI (wt %) | 20 | 20 | 20 |
| | Synthetic rubber (wt %) | 35 | 35 | 35 |
| Additive | Flame retardant (PHR) | 30 | 30 | 30 |
| formula | Inorganic filler (PHR) | 60 | 60 | 60 |
| Evaluation | Tg (° C.) | 215 | 275 | 278 |
| | CTE (ppm/° C. @ 20° C.) | 19 | 14 | 13 |
| | Peel strength (lb/in) | 4.6 | 5.7 | 5.9 |
| | Water absorption @PCT 2 hr | 0.23 | 0.31 | 0.35 |
| | (%) | | | |
| | Heat resistance @PCT 2 hr | OK | OK | OK |
| | Dk (10 GHz) | 3.38 | 3.36 | 3.34 |
| | Df (10 GHz) | 0.0032 | 0.0034 | 0.0035 |

TABLE 3

| | | Example 2-3 | Example 2-4 | Example 2-5 |
|---|---|---|---|---|
| Basic | A3 modified resin (wt %) | 45 | 0 | 0 |
| formula | A4 modified resin (wt %) | 0 | 45 | 45 |
| | BMI (wt %) | 20 | 20 | 20 |
| | Rubber (wt %) | 35 | 35 | 35 |
| Additive | Flame retardant (PHR) | 30 | 30 | 30 |
| formula | Inorganic filler (PHR) | 60 | 60 | 45 |
| Evaluation | Tg (° C.) | 274 | 281 | 271 |
| | CTE (ppm/° C. @ 20° C.) | 15 | 15 | 19 |
| | Peel strength (lb/in) | 5.2 | 5.3 | 5.7 |
| | Water absorption @PCT 2 hr | 0.33 | 0.32 | 0.27 |
| | (%) | | | |
| | Heat resistance @PCT 2 hr | OK | OK | OK |
| | Dk (10 GHz) | 3.38 | 3.36 | 3.28 |
| | Df (10 GHz) | 0.0036 | 0.0036 | 0.0036 |

### Evaluation Method

a. Glass Transition Temperature (Tg)

Similar to the above method, the glass transition temperatures (Tg) of the films formed by the resin compositions of the above formulas were measured by a dynamic mechanical analyzer (DMA).

b. Coefficient of Thermal Expansion (CTE)

Similar to the above method, the coefficients of thermal expansion (CTEs) of the films formed by the resin compositions of the above formulas were measured by a thermomechanical analyzer (TMA) at a heating rate of about 20° C./min.

c. Peel Strength

Similar to the above method, the peel strengths of the films formed by the resin compositions of the above formulas were measured by a universal tensile machine according to IPC-TM-650, Method 2.4.8.

d. Water Absorption

A 5 cm×5 cm square test piece was taken and placed in an oven at about 105° C. for a suitable measurement time (for example: about 2 hours), then the test piece was put in a pressure cooker. The ambient condition in the pressure cooker was about 2 atm×120° C. After about 120 minutes in the pressure cooker, the weight difference of the test piece before and after the pressure cooker was recorded÷the initial weight of the test piece×100%, which was the water absorption.

e. Heat Resistance

The test method was to immerse the above pressure cooker test piece in a soldering furnace at 288±5° C. for observation. If there was no delamination, the heat resistance was recorded as “OK”.

f. Dielectric Constant (Dk)

Dielectric constant test: the test method was to bake a copper foil substrate with the copper foil removed of about 5 cm×5 cm square test piece in an oven at about 105° C. for about 2 hours, and measure the thickness with a thickness measuring instrument, then clamp the test piece into an impedance analyzer (Agilent E4991A) to measure the dielectric constant Dk data of 3 points and take the average value.

g. Dissipation Factor (Df)

Dissipation factor test: the test method was to bake a copper foil substrate with the ketone foil removed of about 5 cm×5 cm square test piece in an oven at about 105° C. for about 2 hours, and measure the thickness with a thickness measuring instrument, then clamp the test piece into an impedance analyzer (Agilent E4991A) to measure the dissipation factor Df data of 3 points and take the average value.

### Evaluation Results

Known from the experimental results in [Table 2], [Table 3], in <Example 2-1> to <Example 2-5>, with the use of the modified naphthol resin of an embodiment of the invention, the heat resistance may be better, the coefficient of thermal expansion may be lower, and higher adhesion was achieved. Moreover, the low hygroscopicity standard of general copper clad laminate (CCL) was still met. In addition, Dk and Df also still met the dielectric level of general copper foil substrates (for example: Df was at a very low loss level of 0.0030 to 0.0065).

Moreover, compared with the use of traditional resins (such as polyphenylene ether resins used in the manufacture of general copper foil substrates), the rest of the properties may be equivalent or within the corresponding standard specifications.

### Industrial Applicability

Moreover, the modified naphthol resin according to the above embodiment of the invention may be directly or indirectly applied to a copper foil substrate, and may be further processed to become other electronic elements or electronic products (such as: circuit boards or copper foil substrates) for livelihood, industry, or suitable applications.

What is claimed is:

1. A preparation method of a modified naphthol resin, comprising:
subjecting a naphthol resin to a salification and a chemical grafting reaction to form the modified naphthol resin having a terminal alkenyl group in a structure thereof,
wherein a reagent used in the chemical grafting reaction has the terminal alkenyl group.

2. The preparation method of the modified naphthol resin of claim 1, wherein the naphthol resin has a structure represented by a following [Formula 1]: 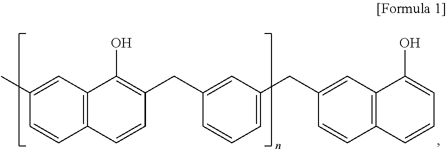
in [Formula 1], n is a positive integer of 2 to 40.

3. The preparation method of the modified naphthol resin of claim 1, wherein an electrophile used in the chemical grafting reaction comprises halide, alkene halide, or alkene acid anhydride.

4. The preparation method of the modified naphthol resin of claim 3, wherein the electrophile comprises halomethylstyrene, acrylic anhydride, methacrylic anhydride, or methacryloyl chloride.

5. A modified naphthol resin, having a structure represented by a following [Formula 3]: 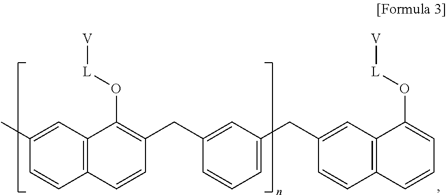
in [Formula 3], V is a vinyl group, an allyl group, or an isopropenyl group,
L is a linking group having a double bond, and
n is a positive integer of 2 to 40.

6. The modified naphthol resin of claim 5, wherein L is a ketone group.

7. The modified naphthol resin of claim 5, wherein L is methylbenzyl group substituted or not substituted with an alkyl group.

8. The modified naphthol resin of claim 5, prepared by a preparation method comprising:
subjecting a naphthol resin to a salification and a chemical grafting reaction to form the modified naphthol resin having a terminal alkenyl group in a structure thereof,
wherein a reagent used in the chemical grafting reaction has the terminal alkenyl group.

9. A resin composition, comprising:
a modified naphthol resin having a structure represented by a following [Formula 3]: 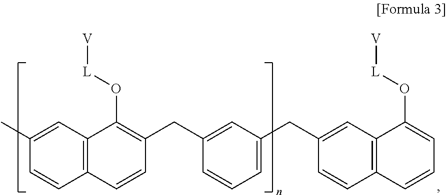
in [Formula 3], V is a vinyl group, an allyl group, or an isopropenyl group,
L is a linking group having a double bond, and
n is a positive integer of 2 to 40.

10. An electronic element, comprising:
a film layer formed by the resin composition comprising a modified naphthol resin having a structure represented by a following [Formula 3]: 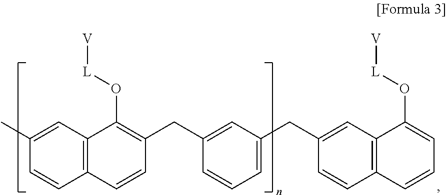
in [Formula 3], V is a vinyl group, an allyl group, or an isopropenyl group,
L is a linking group having a double bond, and
n is a positive integer of 2 to 40.
